(19) United States
(12) Patent Application Publication
(10) Pub. No.: US 2017/0208443 A1
(43) Pub. Date: Jul. 20, 2017

(54) METHOD OF ADAPTIVELY REPORTING BUFFER STATUS BY A DSDS TERMINAL

(71) Applicant: Samsung Electronics Co., Ltd., Gyeonggi-do (KR)

(72) Inventors: Ashish Kumar GUPTA, Bangalore (IN); Balaji Srinivasan THIRUVENKATACHARI, Bangalore (IN); Rohit KUMAR, Bangalore (IN); Shrinath Ramamoorthy MADHURANTAKAM, Bangalore (IN); Swapnil Vinod KHACHANE, Bangalore (IN)

(73) Assignee: Samsung Electronics Co., Ltd.

(21) Appl. No.: 15/228,453

(22) Filed: Aug. 4, 2016

(30) Foreign Application Priority Data
Jan. 14, 2016 (IN) 201641001361CS

(51) Int. Cl. H04W 4/16; H04W 76/02; H04W 72/12

(52) U.S. Cl. CPC H04W 4/16; H04W 72/1268; H04W 76/026; H04W 88/06

(57) ABSTRACT

A method of adaptively reporting buffer status by a dual subscriber identity module dual standby (DSDS) terminal is provided. The method includes computing a rate at which uplink (UL) grants are allocated by a network over a period of time for a first subscriber unit associated with the DSDS terminal, determining a first time period to initiate buffer status reporting (BSR) using a radio frequency (RF) unit, wherein the first time period corresponds to a time period in which a BSR interval initializes, determining a second time period in which a second subscriber unit associated with the DSDS terminal requires the RF unit, and adaptively reporting the buffer status based on the rate and a difference between the second time period and the first time period.

### PRIORITY

This application claims priority under 35 U.S.C. §119(a) to Indian Complete Patent Application Serial No. 201641001361 (CS), which was filed on Jan. 14, 2016, in the Indian Intellectual Property Office, the entire content of which is incorporated herein by reference.

### BACKGROUND

1. Field of the Disclosure

The present disclosure generally relates to buffer status reporting (BSR) to a network, and more particularly, to a method of adaptively reporting buffer status to a network by a dual SIM (subscriber identity module) dual standby (DSDS) terminal.

2. Description of the Related Art

A dual SIM dual standby (DSDS) terminal includes two SIMs (subscriber identity module). In a DSDS terminal, both SIMs shares a single radio frequency (RF) unit for their respective network communications. At any point in time, only one SIM may use the RF unit.

Considering a scenario, in which a first SIM in the DSDS terminal utilizes the RF unit for data communication with its network, the first SIM will indicate the uplink buffer status report (BSR) to the network. In the meantime, a second SIM in the DSDS terminal requires the RF unit for communication with its respective network. However, the first SIM is unaware that the second SIM requires the RF unit for communication and the data communication will get interrupted. Hence, the first SIM may not able to use the allocated resource efficiently since the RF unit has been utilized by the second SIM. Further, this leads to low throughput due to non-optimal utilization of the allocated resources.

Thus, there is a need for a method for adaptively reporting the buffer status for efficient usage of network allocated resources.

### SUMMARY

According to an aspect of the present disclosure, a method of adaptively reporting buffer status by a DSDS terminal is provided.

According to another aspect of the present disclosure, a method of computing a rate at which uplink (UL) grants are allocated by a network over a period of time is provided.

According to another aspect of the present disclosure, a method of adaptively reporting buffer status based on the rate computed through a static method is provided.

According to another aspect of the present disclosure, a method of adaptively reporting buffer status based on the rate computed through a dynamic method is provided.

According to another aspect of the present disclosure, a method to determine a time period to initiate buffer status reporting is provided.

According to another aspect of the present disclosure, a method to determine a time period in which a second subscriber unit associated with the DSDS terminal requires a RF unit is provided.

Accordingly, an aspect of the present disclosure provides a method of adaptively reporting buffer status by a dual SIM dual standby (DSDS) terminal. The method includes computing, by a stack coordinator unit, a rate at which uplink (UL) grants are allocated by a network over a period of time for a first subscriber unit associated with the DSDS terminal. Further, the method includes determining, by the stack coordinator unit, a first time period to initiate buffer status reporting (BSR) using a radio frequency (RF) unit. The first time period corresponds to a time period in which a BSR interval initializes. Further, the method includes determining, by the stack coordinator unit, a second time period in which a second subscriber unit associated with the DSDS terminal requires the RF unit. Furthermore, the method includes adaptively reporting the buffer status based on the rate at which uplink (UL) grants are allocated by a network over a period of time and the difference between the second time period and the first time period.

According to another aspect of the present disclosure, a dual SIM dual standby (DSDS) terminal for adaptively reporting buffer status is provided. The DSDS terminal includes a stack coordinator unit configured to compute the rate at which UL grants are allocated by a network over a period of time for a first subscriber unit associated with the DSDS terminal. Further, the stack coordinator unit is configured to determine a first time period to initiate BSR using an RF unit. The first time period corresponds to a time period in which a BSR interval initializes. Further, the stack coordinator unit is configured to determine a second time period in which a second subscriber unit associated with the DSDS terminal requires the RF unit. Further, the first subscriber unit is configured to adaptively report the buffer status based on the rate at which UL grants are allocated by a network over a period of time and the difference between the second time period and the first time period.

According to another aspect of the present disclosure, a non-transitory computer readable storage medium is provided in which a program for executing operations is recorded, the operations comprising computing a rate at which uplink (UL) grants are allocated by a network over a period of time for a first subscriber unit associated with the dual subscriber identity module dual standby (DSDS) terminal, determining a first time period to initiate buffer status reporting (BSR) using a radio frequency (RF) unit, wherein the first time period corresponds to a time period in which a BSR interval initializes, determining a second time period in which a second subscriber unit associated with the DSDS terminal requires the RF unit, and adaptively reporting the buffer status based on the rate and a difference between the second time period and the first time period.

### BRIEF DESCRIPTION OF THE DRAWINGS

The present disclosure is illustrated in the accompanying drawings, throughout which similar reference numerals indicate corresponding parts in the various figures. The embodiments herein will be better understood from the following description with reference to the accompanying drawings, in which:

FIG. 1 illustrates a system for adaptively reporting buffer status to a network by a dual SIM dual standby (DSDS) terminal, according to an embodiment of the present disclosure;

FIG. 2 is a flowchart illustrating a method for adaptively reporting buffer status to a network by the DSDS terminal, according to an embodiment of the present disclosure;

FIG. 3 is a flowchart illustrating a method for calculating an average of uplink (UL) grant windows in the DSDS terminal to compute the rate at which the UL grants are allocated by a network over a period of time for a first subscriber, according to an embodiment of the present disclosure;

FIG. 4A illustrates a timing diagram for adaptive buffer status reporting (BSR) to a network at time T, according to an embodiment of the present disclosure;

FIG. 4B illustrates a timing diagram for adaptive BSR to a network at time T+t1, according to an embodiment of the present disclosure;

FIG. 5A illustrates a timing diagram for demonstrating a sliding/dynamic grant window for computing a dynamic grant rate and reporting adaptive BSR to a network, according to an embodiment of the present disclosure;

FIG. 5B illustrates another timing diagram for demonstrating a sliding/dynamic grant window for computing a dynamic grant rate and reporting adaptive BSR to a network, according to an embodiment of the present disclosure;

FIG. 6 illustrates a timing diagram for adaptively reporting BSR from time T to T1 by gradually decreasing BSR, according to an embodiment of the present disclosure; and

FIG. 7 illustrates a computing environment implementing the method of adaptively reporting buffer status by a dual subscriber identity module dual standby (DSDS) terminal, according to an embodiment of the present disclosure.

### DETAILED DESCRIPTION

The embodiments herein and various features and advantages thereof are explained more fully with reference to the non-limiting embodiments that are illustrated in the accompanying drawings and detailed in the following description. Descriptions of well-known components and processing techniques are omitted so as to not unnecessarily obscure the embodiments herein. The various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended to facilitate an understanding of ways in which the embodiments herein may be practiced and to further enable those skilled in the art to practice the embodiments herein. Accordingly, the examples should not be construed as limiting the scope of the embodiments herein.

Aspects of the present disclosure will be better appreciated and understood when considered in conjunction with the following description and accompanying drawings. It should be understood, however, that the following descriptions, while indicating preferred embodiments and numerous specific details thereof, are provided by way of illustration and not of limitation. Many changes and modifications may be made within the scope of the embodiments herein without departing from the spirit thereof, and the embodiments herein include all such modifications.

Throughout the description, the terms resources and grants are used interchangeably. In the conventional BSR by the DSDS terminal, the first subscriber unit utilizes the RF unit to indicate the uplink buffer status to the network. In response, the network will allocate resources/grants to the DSDS terminal to transmit data in the uplink. While the data is transmitted, the second subscriber unit requires the RF unit for communication with its respective network. However, the first subscriber unit is unaware that the second subscriber unit requires the RF unit for communication, and the data communication will get interrupted. Hence, the first subscriber unit may not able to use the allocated UL grants efficiently since the RF unit has been utilized by the second subscriber unit leading to low throughput due to non-optimal utilization of the allocated resources.

Unlike the conventional methods of reporting buffer status to the network, the method of the present disclosure adaptively reports buffer status by the first subscriber unit to the respective network. The first subscriber unit utilizes the RF unit for data communication with the network. The first subscriber unit adaptively indicates the BSR to the network by knowing the parameters such as the average rate at which the network is providing the uplink grants over a period of time and the time in which the second subscriber unit requires the RF unit. Thus, by knowing these parameters, the DSDS terminal computes adaptive BSR for uplink grants. Thus, adaptive reporting of the buffer status to the network helps in optimal utilization of allocated UL grants.

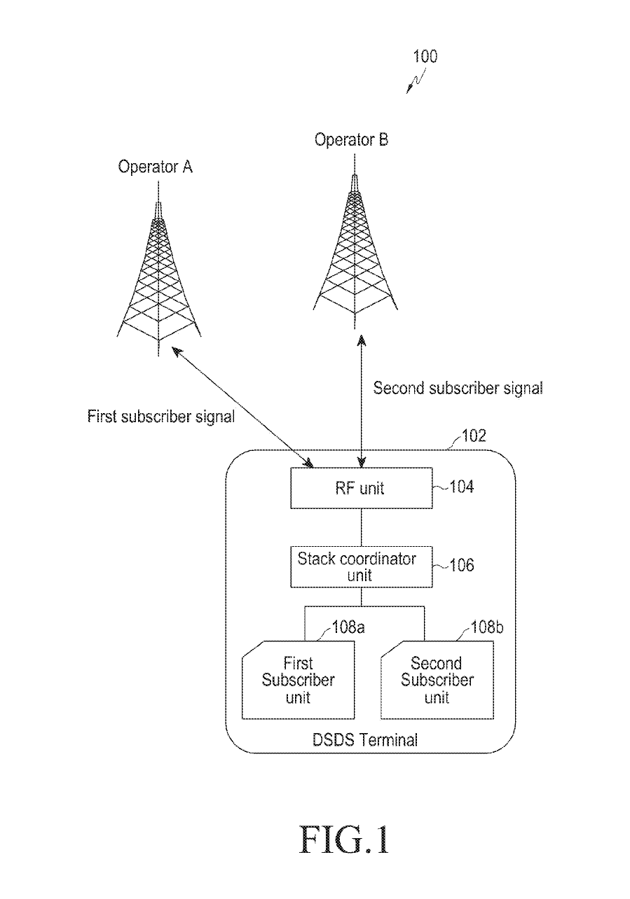

Referring to the drawings, and more particularly to FIGS. 1 through 6, where similar reference numerals denote corresponding features consistently throughout the figures, embodiments of the present disclosure are disclosed.

FIG. 1 illustrates a system for adaptively reporting buffer status to a network by a dual subscriber identity module dual standby (DSDS) terminal 102, according to an embodiment of the present disclosure. The system 100 includes a DSDS terminal 102, a radio frequency (RF) unit 102, a stack coordinator unit 106, a first subscriber unit 108a and a second subscriber unit 108b. The DSDS terminal 102 described herein may be a mobile phone, a smart phone, a personal digital assistant (PDA), a tablet, a phablet, a consumer electronic device, or any other electronic device with two subscriber identity module (SIM) cards or two subscriber units.

The first subscriber unit 108a in the DSDS terminal 102 communicates to the operator A through the RF unit 104.

The second subscriber unit 108b in the DSDS terminal 102 communicates to the operator B through the RF unit 104.

In an embodiment of the present disclosure, the operator A and operator B belong to the same network provider.

In another embodiment of the present disclosure, the operator A and operator B belong to different network providers.

When there is uplink data to be sent to the operator A, the first subscriber unit 108a reports the BSR. The stack coordinator unit 106 computes a rate at which a network is allocating UL grants for data transfer over a period of time for first subscriber unit 108a. In an example, the computed rate provides a real time value according to network loading. Further, the stack coordinator unit 106 determines a first time period (time at which adaptive BSR reporting mechanism initializes) to initiate BSR to the operator A using RF unit 104. The first time period corresponds to a time period in which a BSR interval initializes. Further, the stack coordinator unit 106 determines a second time period in which a second subscriber unit 108b requires the RF unit 104 for communication with the network operator B. The stack coordinator unit 106 determines the first time period based on one or many factors such as, but not limited to, a current UL grant rate, a current buffer status, and an RF unavailable period. Further, the first subscriber unit 108a adaptively reports BSR based on the computed rate by computing an average rate of the UL grants over a period of time and the difference between the second time period and the first time period. The difference in time period indicates the time in which the second subscriber unit 108b requires the RF unit 104 for its communication.

In an embodiment of the present disclosure, the adaptive BSR may be computed using Equation (1) as below:

B1=R*(T1−T) (1)

where B1 denotes computed BSR, T denotes current time (time at which adaptive BSR mechanism initializes and subsequent BSR occasions before T1), T1 denotes RF sharing time (time at which second subscriber 108b will start using the RF unit 104), and R=Rate (average rate of the UL grant window over a period of time ‘Delta=D’ i.e., D is an UL grant window length of prior grants. The size of D may be fixed or variable).

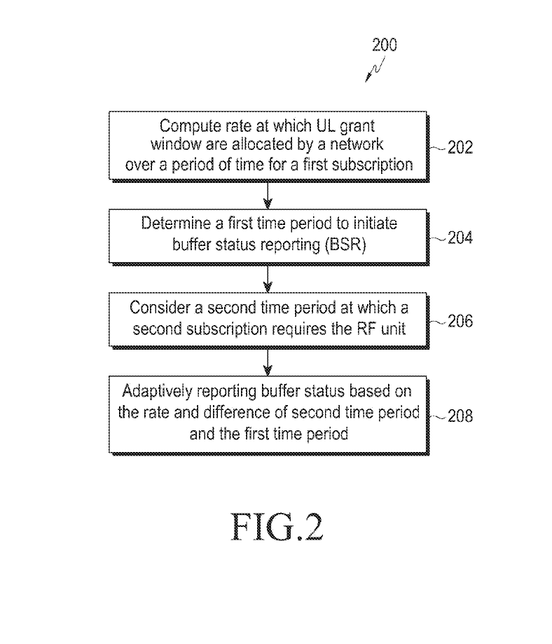

FIG. 2 is a flowchart illustrating a method for adaptively reporting buffer status to a network by the DSDS terminal, according to an embodiment of the present disclosure.

Referring to FIG. 2, at step 202, the method 200 includes computing a rate at which the UL grants are allocated by the network over a period of time for first subscriber unit 108a. The method 200 allows the stack coordinator unit 106 to compute the rate at which the network is allocating UL grants for data transfer over a period of time for first subscriber unit 108a. As an example, consider previous 5 UL grants allocated by the network to the first subscriber unit 108a, the stack coordinator unit 106 computes the amount of grants received from the network during the previous 5 grants. Accordingly, the stack coordinator 106 computes the average rate of the previous 5 grants allocated by the network. At step 204, the method 200 includes determining a first time period to initiate the BSR to the network. The method 200 allows the stack coordinator unit 106 to determine a first time period to initiate BSR using RF unit 104. The first time period corresponds to a time period in which a BSR interval initializes. As an example, after calculating the rate by computing the average of 5 previous UL grants to the first subscriber unit 108a, the stack coordinator unit 106 determines a first time period to initiate the BSR to the network based on factors such as, and not limited to, a current UL grant rate, a current buffer status and an RF unavailable period.

At step 206, the method 200 includes determining a second time period in which a second subscriber unit 108b requires the RF unit 104. The method 200 allows the stack coordinator unit 106 to determine a second time period in which a second subscriber unit 108b associated with the DSDS terminal 102 requires the RF unit 104 for communication with its respective network. The stack coordinator unit 106 determines the second time period which is pre-stored in the stack coordinator unit 106. As an example, the second SIM needs the RF unit to communicate with the operator for receiving paging information.

At step 208, the method 200 includes adaptively reporting buffer status based on the computed rate and the difference between the second time period and the first time period. The method 200 allows the first subscriber unit 108a to adaptively report the BSR based on the computed rate by calculating the average rate of the UL grants over a period of time and the difference between the second time period and the first time period. The difference in time period is the time difference from the current time to the time at which the second subscriber unit 108b requires the RF unit 104 for its communication. Based on the reported BSR, the network allocates UL grants for the first subscriber unit 108a. Hence, the network UL grants are optimally utilized even though the RF unit 104 is shared with the second subscriber unit 108b at a later point of time.

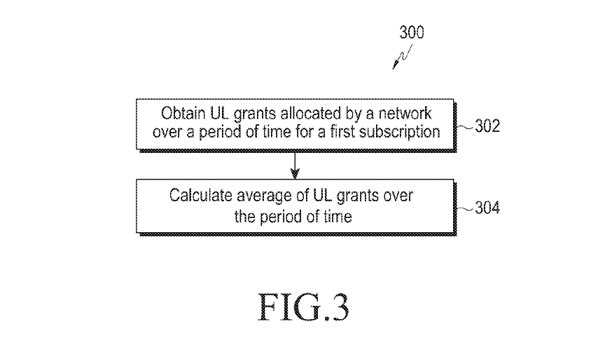

FIG. 3 is a flowchart illustrating a method for calculating an average of uplink (UL) grant windows in the DSDS terminal to compute the rate at which the UL grants are allocated by a network over a period of time for a first subscriber, according to an embodiment of the present disclosure.

Referring to FIG. 3, at step 302, the method 300 includes obtaining UL grants allocated by a network over a period of time for the first subscriber unit 108a. The method 300 allows the stack coordinator unit 106 to obtain the UL grants allocated by the network over the period of time for the first subscriber unit 108a.

At step 304, the method 300 includes calculating an average of UL grants over the period of time. The method 300 allows the stack coordinator unit 106 to calculate an average of UL grants over the period of time. In an embodiment of the present disclosure, the stack coordinator unit 106 continuously obtains UL grants allocated by the network for the prolonged period of time.

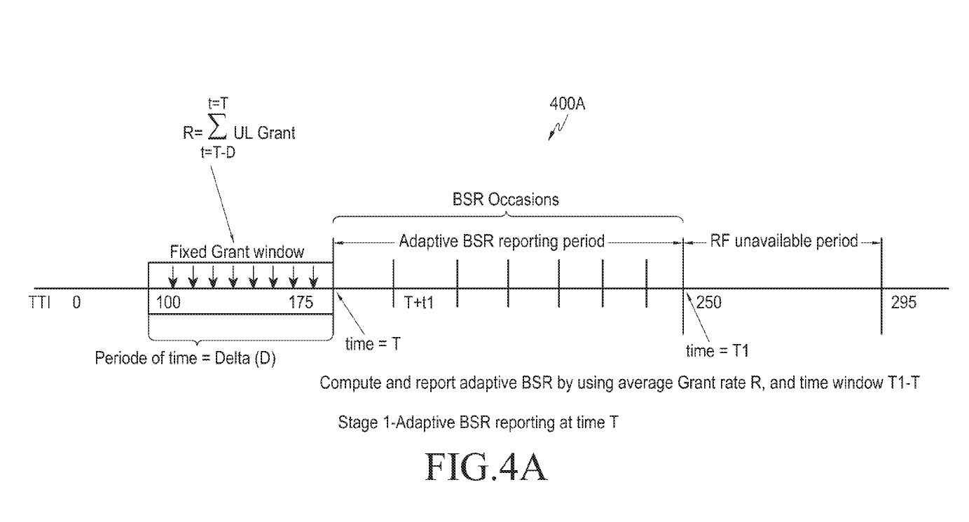

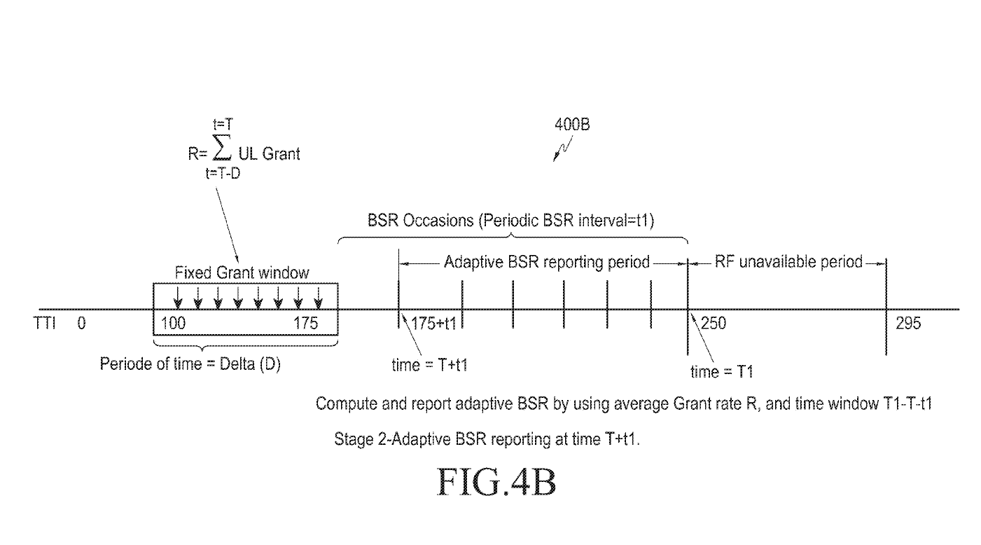

FIG. 4A illustrates a timing diagram for adaptive buffer status reporting (BSR) to a network at time T, according to an embodiment of the present disclosure.

The timing diagram 400A provides an example of computing the BSR adaptively through a static method. The static method refers to computing an average grant rate of all the individual UL grants available in the fixed grant window from 100 ms to 175 ms as shown in FIG. 4A.

The stack coordinator unit 106 computes the rate ‘R’ through the static method. The stack coordinator unit 106 obtains all the individual UL grants available in a fixed grant window over a time period of 100 ms to 175 ms as shown in FIG. 4A and the difference between the 175 ms and 100 ms is considered to be the delta time which is denoted as ‘D’. Further, the stack coordinator unit 106 computes the average of all the individual UL grants available in the fixed grant window and computes the rate denoted as R. As an example, initially at time Al the network allocates 25 Mb, at time A2 the network allocates 27 MB and at time A3 the network allocates 30 MB. The stack coordinator unit 106 computes the average of the allocated resources i.e., (25+27+30)/3=27.33 MB. The equation to compute ‘R’ is given in Equation (2) below.

$$R = {\sum }_{t = T - D}^{t = T} UL Grant \qquad ( 2 )$$

The stack coordinator unit 106 considers the rate R to compute BSR at every BSR occasion between the time periods from T to T1. The BSR occasions are segmented into a series of intervals called buffer status intervals (BSIs). Each BSI is denoted as t1, which is shown in FIG. 4A. Further, the stack coordinator unit 106 determines the time period in which the BSR will be initialized which is denoted as T. Further, the stack coordinator unit 106 determines a second time period (T1) at which a second subscriber unit 108b requires the RF unit 104. Further, the stack coordinator unit 106 adaptively reports the buffer status based on the computed rate R and the time window T1−T.

FIG. 4B illustrates a timing diagram for adaptive BSR to a network at time T+t1, according to an embodiment of the present disclosure.

The timing diagram 400B provides an example of computing the BSR through the static method at a reduced time T+t1. In FIG. 4A, the stack coordinator unit 106 initiates BSR at time T, whereas in the FIG. 4B, the time is shifted from T to T+t1. Thus, the stack coordinator unit 106 determines the shifted time from T to T+t1 and indicates the BSR to the network at time T+t1. As an example, let us consider the stack coordinator unit 106 reporting its buffer status to the network every 5 ms, denoted as t1. For example, the stack coordinator unit 106 initiates reporting buffer status at time T_{BSR}. Further, the stack coordinator initiates its next buffer status reporting at T_{BSR}+5.

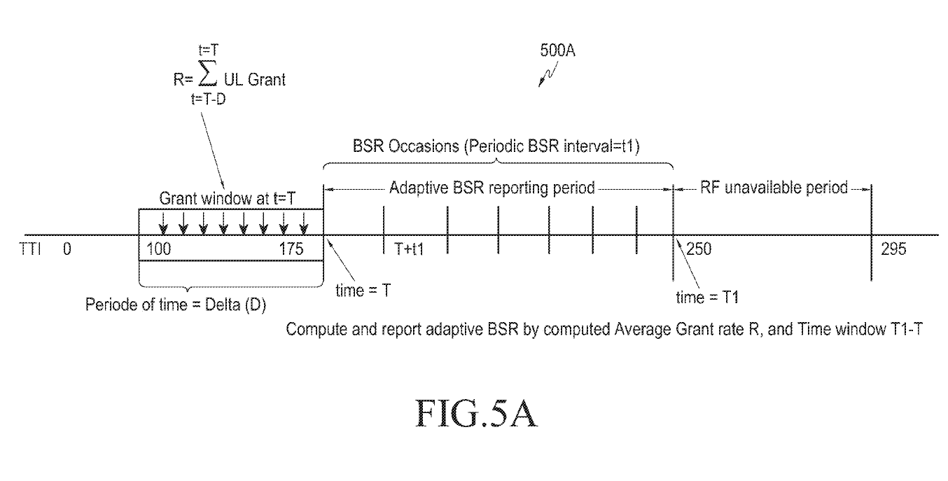

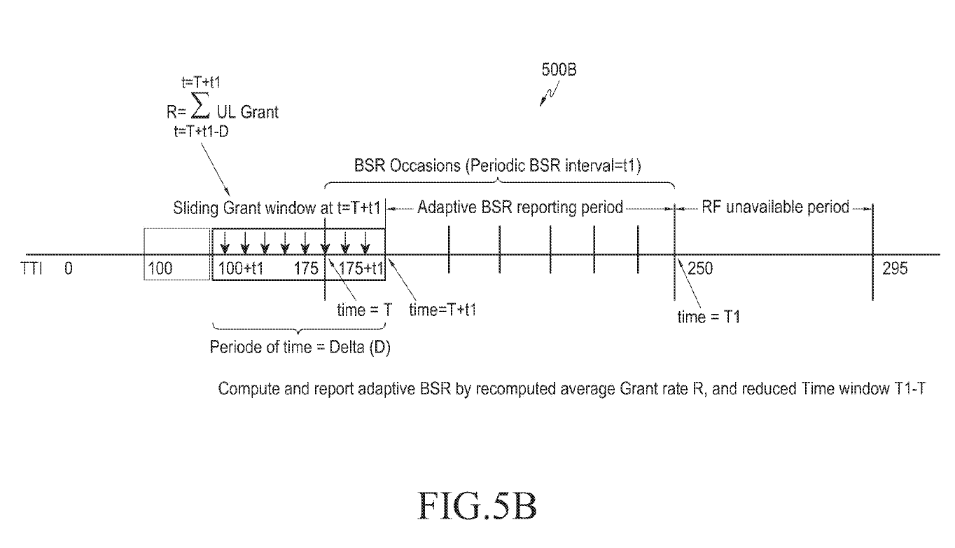

FIGS. 5A and 5B illustrate timing diagrams for demonstrating a sliding/dynamic grant window for computing dynamic grant rate and reporting adaptive BSR to a network, according to an embodiment of the present disclosure.

The timing diagrams 500A and 500B depict a dynamic method, where the grant window is a sliding grant window which is shifted over a time axis from 100 ms, as shown in FIG. 5A, to 100+t1 ms as shown in FIG. 5B. The dynamic method of computing a rate denoted by R refers to computing an average grant rate of all the individual UL grants available on the sliding grant window from 100+t1 to 175+t1 as shown in FIG. 5B.

The stack coordinator unit 106 computes the rate through a dynamic method at every BSR occasion. The stack coordinator unit 106 obtains all the individual UL grants available on a sliding grant window over a time period from 100+t1 to 175+t1 as shown in the FIG. 5B and the time period is considered to be the delta time which is denoted as D. Further, the stack coordinator unit 106 takes the average of all the individual UL grants available in the sliding grant window and computes the rate denoted as R. Further, the stack coordinator unit 106 uses the computed R at every BSR occasion between the time periods T+t1 to T1 as shown in the FIG. 5B. The computed R is used at every BSR occasion to calculate the adaptive BSR. Further, the stack coordinator unit 106 determines the current time period T+t1 at which the BSR is initialized using the RF unit 104. Further, the stack coordinator unit 106 determines a second time period T1 at which a second subscriber 108b associated with the DSDS terminal requires the RF unit 104. Further, the stack coordinator unit 106 computes and reports adaptive BSR using the computed R and the reduced time window difference from T1−T−t1.

In an embodiment of the present disclosure, the equation to compute ‘R’ is given by Equation (3) below:

$$R = {\sum }_{t = T + t 1 - D}^{t = T + t 1} UL Grant \qquad ( 3 )$$

In an embodiment of the present disclosure, the computation of ‘R’ as described in FIGS. 4A-4B, 5A-5B may be combined to optimally utilize the network UL grants in a given time period.

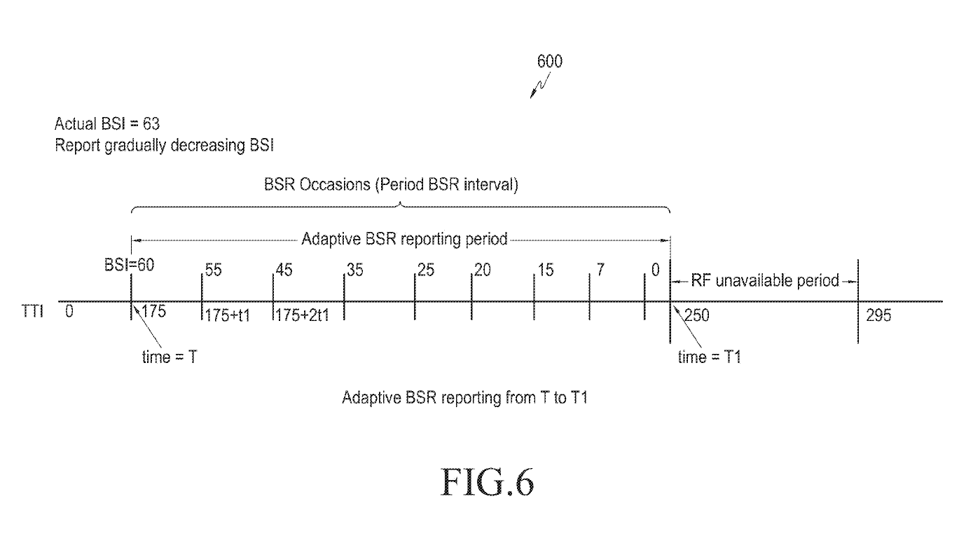

FIG. 6 illustrates a timing diagram for adaptively reporting BSR from T to T1 by gradually decreasing BSR, according to an embodiment of the present disclosure.

1. The timing diagram reporting the BSR in decreasing order at multiple BSR occasions from time T to T1 is shown in FIG. 6. Further, the stack coordinator unit 106 determines a time period T1 at which a second subscriber unit 108b requires the RF unit 104. The stack coordinator unit 106 reports to the network, a decremented value of UL data associated with the first subscriber unit 108a of the DSDS terminal 102 at every BSR occasion from time T to T1. The stack coordinator unit 106 reports decreasing buffer status instead of actual buffer status. Hence, the network UL grants are optimally utilized even though the RF unit 104 is shared with the second subscriber unit 108b at T1. As shown in FIG. 6, actual buffer status index (BSI) 63 (i.e. actual BSR>150000 bytes) of data is to be reported by the first subscriber unit 108a to the network before the RF unit 104 unavailable time at T1=250 ms. BSI and BSR are defined in long term evolution (LTE) third generation partnership project (3GPP) specification No. 36.321. The BSI and BSR may be associated with wireless networks based on protocols including fifth generation (5G), long term evolution (LTE), long term evolution advanced (LTE-A), code division multiple access (CDMA), wideband code division multiple access (WCDMA), universal mobile telecommunications system (UMTS), and global system for mobile communication (GSM). Based on the availability of the RF unit 104, the stack coordinator unit 106 reports the adaptive BSR for the RF unit 104 available time period T1−T i.e., 250−175=75 ms into a plurality of intervals known as BSR occasions. The stack coordinator unit 106 reports adaptive BSR for the RF unit 104 available time i.e., 75 ms into a plurality of intervals (for example, 8 intervals) at BSR occasions. Further, the stack coordinator unit 106 reports BSI 60 in a decremented fashion instead of reporting the actual BSI of 63. Accordingly, the stack coordinator unit 106 reports BSI 60 associated with the first subscriber unit 108a. At time 175 ms, the stack coordinator unit 106 reports BSI 60 to the network, at time 175+t1 the stack coordinator unit 106 reports BSI 55, at time 175+2t1 the stack coordinator unit 106 reports BSI 45, at time 175+3t1 the stack coordinator unit 106 reports BSI 35, at time 175+4t1 the stack coordinator unit 106 reports BSI 25, at time 175+5t1 the stack coordinator unit 106 reports BSI 20, at time 175+6t1 the stack coordinator unit 106 reports BSI 15, at time 175+7t1 the stack coordinator unit 106 reports BSI 7 and at time 175+8t1 the stack coordinator unit 106 reports BSI 0. Thus, the stack coordinator unit 106 reports the adaptive BSR in a decremented fashion before reaching the RF unit 104 unavailability time T1=250 ms.

As another example, 1000 MB of data is to be reported by the first subscriber unit 108a to the network. The stack coordinator unit 106 divides the RF unit 104 available time (for example, 50 ms) associated with first subscriber unit 108a into a fixed number of BSR intervals (for example, 10 ms). Accordingly, the stack coordinator unit 106 reports the 1000 MB data in a gradually decremented method at every BSR interval. At the first interval, the stack coordinator unit 106 reports 400 MB, at the second interval the stack coordinator unit 106 reports 300 MB, at the third interval the stack coordinator unit 106 reports 200 MB, at the fourth interval the stack coordinator unit 106 reports 100 MB and at the fifth interval the stack coordinator unit 106 reports 0 MB.

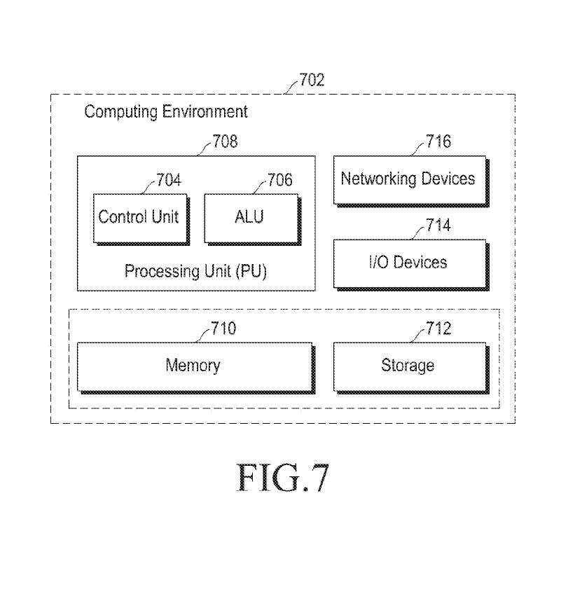

FIG. 7 illustrates a computing environment implementing the method of adaptively reporting buffer status by a dual SIM dual standby (DSDS) terminal, according to an embodiment of the present disclosure. Referring to FIG. 7, the computing environment 702 comprises at least one processing unit 708 that includes a control unit 704 and an arithmetic logic unit (ALU) 706, a memory 710, a storage unit 712, plurality of networking devices 716 and a plurality of input/output (I/O) devices 714. The processing unit 708 is responsible for processing commands and instructions. The processing unit 708 receives commands from the control unit 704 in order to perform its processing. Further, any logical and arithmetic operations involved in the execution of the instructions are computed with the help of the ALU 706.

The embodiments disclosed herein may be implemented by at least one software program running on at least one hardware device and performing network management functions to control the elements. The elements shown in FIG. 1 include blocks which may be at least one of a hardware device, a software module, or a combination of a hardware device and a software module.

The foregoing description of the specific embodiments may be adapted for various applications without departing from the generic concept, and therefore, such adaptations and modifications are within the meaning and range of equivalents of the disclosed embodiments. It is to be understood that the phraseology or terminology employed herein is for the purpose of description and not of limitation. Therefore, while the embodiments herein have been described in terms of certain embodiments, those skilled in the art will recognize that the embodiments herein may be practiced with modification within the spirit and scope of the embodiments as described in the appended claims and their equivalents.

What is claimed is:

1. A method of adaptively reporting buffer status by a dual subscriber identity module dual standby (DSDS) terminal, the method comprising:
computing, by a stack coordinator unit, a rate at which uplink (UL) grants are allocated by a network over a period of time for a first subscriber unit associated with the DSDS terminal;
determining, by the stack coordinator unit, a first time period to initiate buffer status reporting (BSR) using a radio frequency (RF) unit, wherein the first time period corresponds to a time period in which a BSR interval initializes;
determining, by the stack coordinator unit, a second time period in which a second subscriber unit associated with the DSDS terminal requires the RF unit; and
adaptively reporting the buffer status based on the rate and a difference between the second time period and the first time period.

2. The method of claim 1, wherein the computed rate at which UL grants are allocated by the network over the period of time includes calculating an average of UL grants received over the period of time.

3. The method of claim 1, wherein the method further comprises reporting a decremented value of UL data in at least one subsequent the BSR interval.

4. The method of claim 1, wherein the UL grants vary over time.

5. The method of claim 1, wherein the first time period in which a BSR interval initializes is determined based on at least one of a current UL grant rate, a current buffer status, and an RF unavailable period.

6. The method of claim 1, wherein the second time period in which a second subscriber unit associated with the DSDS terminal requires the RF unit is stored in the stack coordinator unit or is determined by a paging interval.

7. The method of claim 1, wherein the network is at least one of fifth generation (5G), long term evolution (LTE), long term evolution advanced (LTE-A), code division multiple access (CDMA), wideband code division multiple access (WCDMA), universal mobile telecommunications system (UMTS), and global system for mobile communication (GSM).

8. A dual subscriber identity module dual standby (DSDS) terminal, the DSDS terminal comprising a stack coordinator unit configured to:
compute a rate at which uplink (UL) grants are allocated by a network over a period of time for a first subscriber unit associated with the DSDS terminal;
determine a first time period to initiate buffer status reporting (BSR) using a radio frequency (RF) unit, wherein the first time period corresponds to a time period in which a BSR interval initializes;
determine a second time period in which a second subscriber unit associated with the DSDS terminal requires the RF unit; and
adaptively report the buffer status based on the rate and a difference between the second time period and the first time period.

9. The DSDS terminal of claim 8, wherein the stack coordinator unit is further configured to compute a rate at which UL grants are allocated by the network over the period of time by calculating an average of UL grants received over the period of time.

10. The DSDS terminal of claim 8, wherein the stack coordinator unit is further configured to report a decremented value of UL data in at least one subsequent the BSR interval.

11. The DSDS terminal of claim 8, wherein the UL grants vary over time.

12. The DSDS terminal of claim 8, wherein the first time period in which a BSR interval initializes is determined based on at least one of a current UL grant rate, a current buffer status, and an RF unavailable period.

13. The DSDS terminal of claim 8, wherein the second time period in which a second subscriber unit associated with the DSDS terminal requires the RF unit is stored in the stack coordinator unit or is determined by a paging interval.

14. The DSDS terminal of claim 8, wherein the network is at least one of fifth generation (5G), long term evolution (LTE), long term evolution advanced (LTE-A), code division multiple access (CDMA), wideband code division multiple access (WCDMA), universal mobile telecommunications system (UMTS), and global system for mobile communication (GSM).

15. A non-transitory computer readable storage medium in which a program for executing operations is recorded, the operations comprising:
computing a rate at which uplink (UL) grants are allocated by a network over a period of time for a first subscriber unit associated with a dual subscriber identity module dual standby (DSDS) terminal;
determining a first time period to initiate buffer status reporting (BSR) using a radio frequency (RF) unit, wherein the first time period corresponds to a time period in which a BSR interval initializes;
determining a second time period in which a second subscriber unit associated with the DSDS terminal requires the RF unit; and
adaptively reporting the buffer status based on the rate and a difference between the second time period and the first time period.

16. The non-transitory computer readable storage medium of claim 15, wherein the computed rate at which UL grants are allocated by the network over the period of time includes calculating an average of UL grants received over the period of time.

17. The non-transitory computer readable storage medium of claim 15, wherein the method further comprises reporting a decremented value of UL data in at least one the subsequent BSR interval.

18. The non-transitory computer readable storage medium of claim 15, wherein the UL grants vary over time.

19. The non-transitory computer readable storage medium of claim 15, wherein the first time period in which a BSR interval initializes is determined based on at least one of a current UL grant rate, a current buffer status, and an RF unavailable period.

20. The non-transitory computer readable storage medium of claim 15, wherein the second time period in which a second subscriber unit associated with the DSDS terminal requires the RF unit is stored in the stack coordinator unit or is determined by a paging interval.
